(19) United States
(12) Patent Application Publication
(10) Pub. No.: US 2006/0258219 A1
(43) Pub. Date: Nov. 16, 2006

(54) ELECTRICAL CONNECTOR

(75) Inventor: Kun-Hua Chen, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/432,859

(22) Filed: May 11, 2006

(30) Foreign Application Priority Data
May 16, 2005 (CN) 200520071782.4

(51) Int. Cl. H01R 13/648

(52) U.S. Cl. 439/607

(57) ABSTRACT

An electrical connector (100) includes a shielding member (3), a terminal block (1) assembled on said shielding member (3), a plurality of terminals (2) received in the terminal block (1). The shielding member comprises a plurality of walls (31, 32, 33, 34), said walls all together defining a receiving space (30). One of said walls includes a cutout (310) therein. The wall with the cutout (310) further comprises a connecting portion (310) extending outwardly and connecting two opposite sides of the cutout (310).

### BACKGROUND OF THE INVENTION

1. Field of the Invention

The present invention relates to an electrical connector, and particularly to an electrical connector used for a mobile phone or other electrical devices having different designs and configurations.

2. Description of the Prior Art

With the rapid development of the technology of wireless communication and advanced technology of electrics, electronic consuming goods such as mobile phone, Personal Digital Assistant (PDA) etc., are designed to comply with miniaturization trend and multiple functions such as mounting a camera on thereof to meet with requirements of human. As a result, the requirement of socket connectors used in such equipments is correspondingly demanding.

Usually, these electrical connectors used for positioning and electrically connecting with the camera each equips with anti-mismating portion. Please with reference to the electrical connector shown in the FIG. 1, the cutout 34′ formed on the one of the shielding wall of the shell 3′ engage with the protrusion 420′ of the electrical member 4′ which can achieve the aim of anti-mismating. However, the cutout 34′ formed on the shell results in reducing the intension of the shell 3′, and the shock arised in the process of mating with a complementary connector or normal usage can distort or rupture the shell 3′. In order to overcome this disadvantage, a strengthening portion is usually provided on the above cutout 34′. To this design, the intension of the shell is no longer to be worried. However this solution is costly and requires an additional space in the connector system since the width of the shield strip having the strengthening portion should be widen.

Hence, an improved electrical connector is desired to overcome the disadvantages of the prior art.

### BRIEF SUMMARY OF THE INVENTION

Therefore, a main object of the present invention is to provide an electrical connector which provides the function of anti-mismating and decreasing the cost.

To fulfill the above-mentioned object, an electrical connector according to the present invention includes a shielding member accommodating an electric device, a terminal block assembled to the shielding member, and a plurality of terminals received in the terminal block. Said shielding member has several walls and a receiving space formed by said walls. One of the walls defines a cutout therein and a connecting portion which extends outwardly and connects two opposite sides of the cutout.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is an exploded view of a conventional electrical connector.

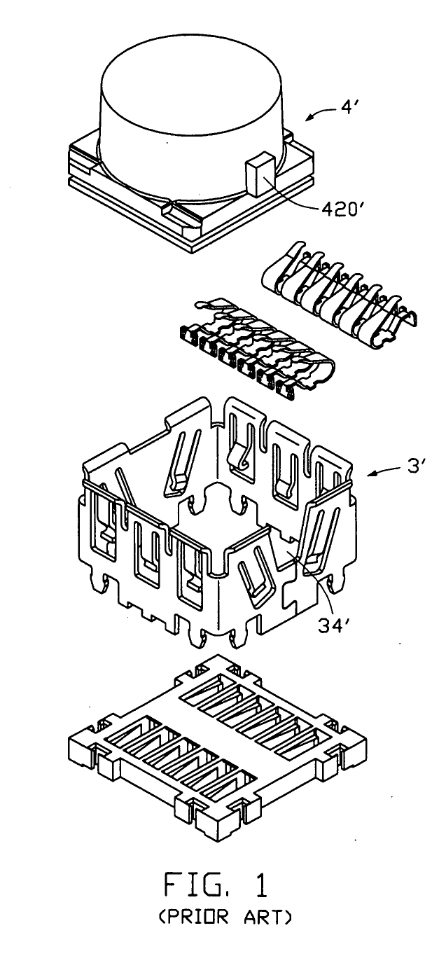

FIG. 2 is a perspective view of an electrical connector with an electrical device according to the present invention.

FIG. 3 is a view similar to FIG. 2, but viewed from another aspect.

FIG. 4 is an exploded view of FIG. 2.

FIG. 5 is a view similar to FIG. 4, but viewed from another aspect.

### DETAILED DESCRIPTION OF THE PREFERRED EMBODIMENT

Reference will now be made in detail to the preferred embodiment of the present invention.

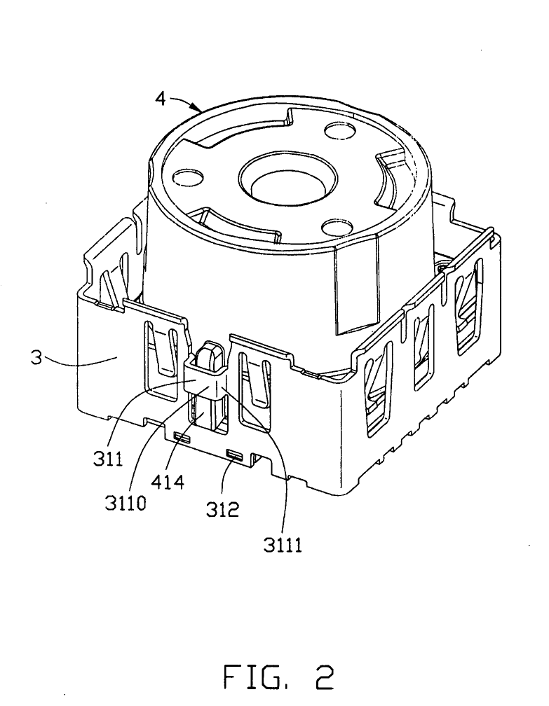

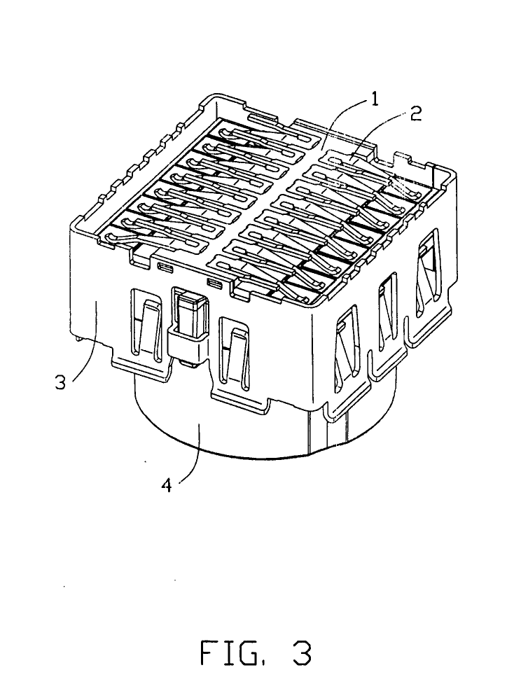

Referring to FIGS. 2-5, an electrical connector 100 according to the present invention is adapted for receiving an electrical device and in this embodiment said electrical device is a camera module 4. The electrical connector 100 comprises a shielding member 3 accommodating said camera module 4, a plurality of terminals and an insert-molding terminal block 1. The terminal block 1 is retained on the bottom of the shielding member 3.

The terminal block 1 includes a rectangular main body 11 and a pair of longitudinal side portions 13 respectively disposed at opposite ends of the main body 11. A plurality of passageways 12 are defined in a bottom of the main body 11. Each side portion 13 comprises a pair of spaced projections 14 for coupling with the shielding member 3.

Each terminal 2 includes an end portion 21, a first branch 211 and a second branch 212 being coplanar with the end portion 21 and bifurcating from the end portion 21 towards the same direction. Said first branch 211 has a tail portion 2110 extending away from the end portion 21, and said second branch 212 has a resilient portion 2120 extending upwardly and away from the end portion 21. The resilient portion 2120 has a contacting portion 2121 at a free end thereof.

The shielding member 3 is firstly stamped from a metal sheet and then bent to form a rectangular configuration shown in the present invention. The shielding member 3 includes a first wall, a second wall, a third wall, a fourth wall 31, 32, 33, 34 which connect with each other in turn to form a receiving space 30. A swallow-tail shaped jointing line 300 is formed near the jointing portion of the third wall 33 and the fourth wall 34. The first wall 31 comprises a cutout 310 defined on a central section thereof, a U-shaped connecting portion 311 protruding outwardly and connecting to two opposite sides of the cutout 310, a pair of resilient tabs 313 symmetrically located at two opposite sides of the cutout 310 respectively, a pair of apertures 312 defined on a low portion of the first wall 31 and a guide portion 314 which is formed on the free end of the first wall 31 and extends outside of the shielding member 3. The cutout 310 includes a bottom edge 370 and the width of the top portion of the cutout 310 is slightly lager than the width of the bottom edge 370. The U-shaped connecting portion 311 is stamped from the first wall 31 and includes a base portion 3110 and two connecting arms 3111 respectively extending vertically from the base portion 3110 and connecting two opposite sides of the cutout 310. The U-shaped connecting portion 311 can overcome the limitation of the low intension caused by the cutout 310 located on the first wall 31, and furthermore the width of the first wall will not be increased since the connecting portion is stamped from the first wall 31. The resilient tab 313 comprises a connecting portion 3130 connecting to the guide portion 314, a curved portion 3131 connecting to connecting portion 3130 and bent toward the inside of the shielding member 3 and a sustaining portion 3132 resisting against the camera module 4. The second and the fourth wall 32, 34 respectively comprises a resilient tab 313 located on the central section thereof, two clasping arms 320 symmetrically located at two sides of the resilient tab 313 and three guide portions 314 respectively connecting with the resilient tab 313 and the clasping arm 320. The third wall 33 comprises a pair of resilient tabs 313, a pair of guide portions 314 connecting to the resilient tab 313 and a pair of apertures 312 located in the low portion of the third wall 33. The resilient tabs 313 of the four walls 31, 32, 33, 34 can symmetrically fix the camera module 4 and establish a grounding connection for the electrical connector 100. The clasping arms 320 of said wall 32, 34 can reliably lock the camera module 4 within the shielding member 3. The guiding portion 314 can easily guide the camera module 4 to be assembled into the shielding member 3.

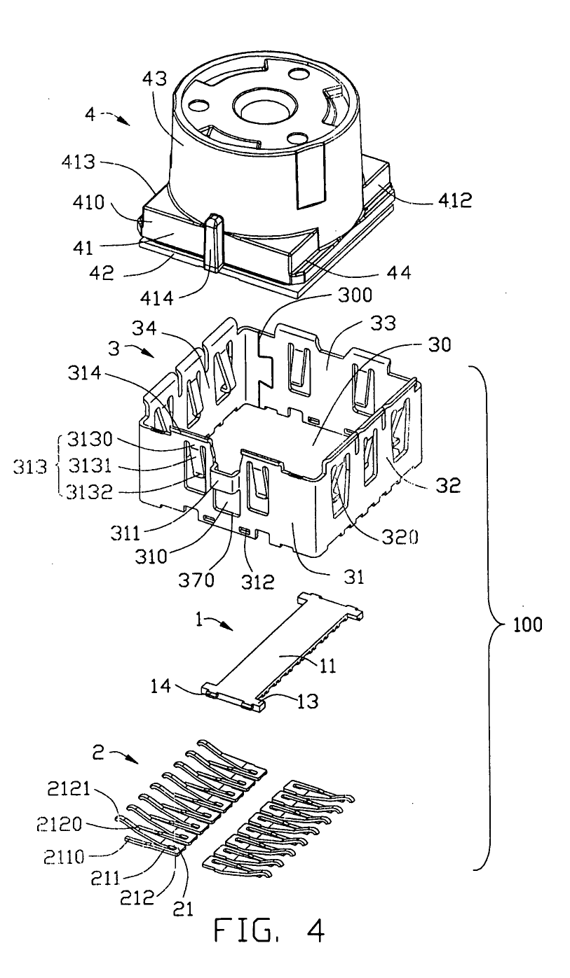

The camera module 4, received in the receiving space 30 of the shielding member 3, comprises a body portion 41, a columnar portion 43 situated on the top of the body portion 41 and a bottom portion 42 located beneath the body portion 41. The body portion 41 includes a front wall 410, two side walls 412, 413 adjoined to the front wall 410, and a back wall (not labeled) opposite to the front wall 410. The side walls 412, 413 each defines a ladder-shaped clasping notch 44 for locking with the clasping tab 320. Referring to FIG. 4, the front wall 410 of the body portion 41 provides an approximately longitudinal rib 414 which may insert into the cutout 310. When the camera module 4 is shocked, the rib 414 resists against the bottom 370 and is received in the U-shape region of the connecting portion 311, so the camera module 4 will not move downwardly. A conductive layer enclosed around the columnar portion 43 can establish an electrical connection with the resilient tab 313 of the shielding member 3. The bottom surface of the bottom portion 42 has a plurality of conductive pads 421 contacting with the contacting portion 2121 of the terminals 2.

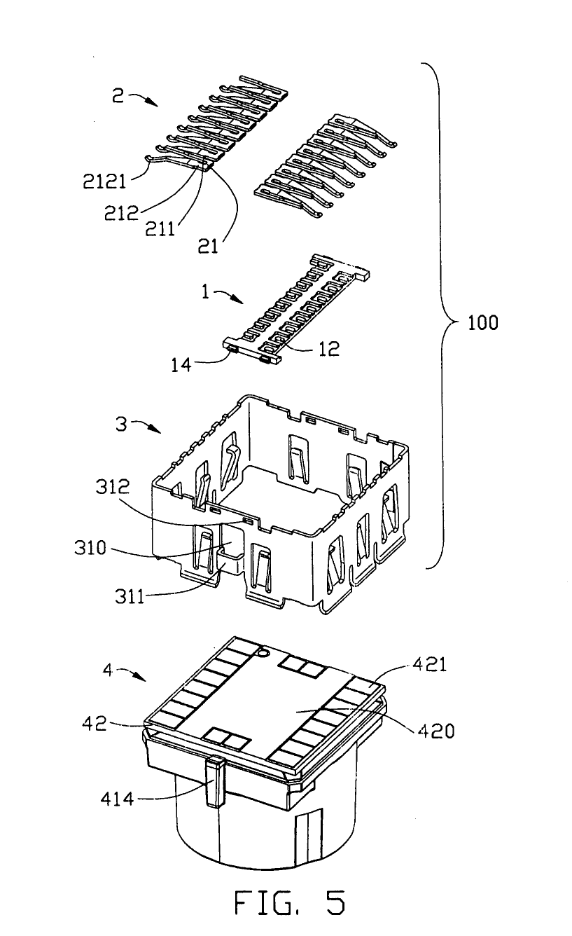

In assembly, referring to FIGS. 4-5, the terminal block 1 is molded from insulative materials with the terminals 2 assembled in. The end portions 21 of the terminals 2 are received in the passageways 12 defined at the opposite sides along the longitudinal direction of the terminal block 1, and the contacting portions 2121 of the terminals extend outwardly from the main body 11. The terminal block 1 with the terminals is assembled to the shielding member 3 with the projections 14 of the side portions 13 of the terminal block 1 received in the apertures 312. The camera module 4 is inserted into the receiving space 30 of the shielding member 3 along a top-to-bottom direction. In the meanwhile, the rib 414 of the camera module 4 is pressed into the cutout 310 of the shielding member 3 due to the pressure caused by the resilient tab 313 and the clasping arm 320. In the process of moving downwardly, the rib 414 engages with the cutout 310. The resilient tabs 313 press against the surface of the columnar portion 43, and the clasping arms 320 engage with the clasping notch 44. Thus, the camera module 4 is stopped and supported by shielding member 3, and can not be moved by shocking. After the camera module 4 is inserted, the conductive pads 421 of the bottom portion 42 of the camera module 4 electrically connect with the contacting portions 21 of the terminals 2 displaced in the terminal block 1.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for receiving an electronic device therein, comprising:
a shielding member comprising a plurality of walls, said walls all together defining a receiving space, and one of said walls defining a cutout therein;
a terminal block assembled on said shielding member; and
a plurality of terminals received in said terminal block;
wherein the wall with the cutout further comprises a connecting portion extending outside and connecting opposite sides of the cutout.

2. The electrical connector as described in claim 1, wherein the connecting portion is stamped from a metal sheet and forms a U-shaped structure, and the connecting portion includes a base portion and a plurality of connecting arms respectively extending vertically from the base portion and connecting opposite sides of the cutout.

3. The electrical connector as claimed in claim 1, wherein the connecting portion is located between opposite sides of the cutout.

4. The electrical connector as claimed in claim 1, wherein the upper width of the cutout is larger than the lower width of the cutout.

5. The electrical connector as claimed in claim 1, wherein the shielding wall with the cutout defines a pair of resilient tabs concaving into the receiving space.

6. The electrical connector as described in claim 1, wherein said shielding member comprises the first, second, third and fourth shielding walls connecting with each other in turns, and said terminal block engages with the first and the third shielding walls.

7. The electrical connector as claimed in claim 6, wherein the first and the third walls each defines an aperture engaging with the projection of the terminal block.

8. The electrical connector as claimed in claim 6, wherein the second and the fourth walls each comprises a resilient tab defined on the central section thereof and a pair of clasping arms symmetrically located at two sides of the resilient tab.

9. The electrical connector as claimed in claim 1, wherein the terminal comprises an end portion, a first branch and a second branch being coplanar with the end portion and bifurcating from the end portion toward the same direction, and wherein said first branch defines a tail portion extending away from the end portion, said second branch defines a resilient portion extending upwardly and away form the end portion, and the resilient portion defines a contacting portion at the free end thereof.

10. The electrical connector as claimed in claim 1, wherein the terminal block engages with the terminals in a way of insert-molding.

11. An electrical connector comprising:
a terminal block having an insulative piece holding a plurality of terminals therein;
a metallic shield enclosing said terminal block, said shield including a plurality of peripheral walls defining a receiving cavity, said shield defining a cutout laterally extending through the corresponding peripheral wall while with a connection protrusion outwardly linking two opposite inner edges of said corresponding wall beside said cutout.

12. The electrical connector as claimed in claim 11, wherein said shield is formed by an extended sheet, and a joined seam line for said peripheral walls is not aligned with said cutout in a vertical direction.

13. An electrical connector assembly comprising:
a terminal block having an insulative piece holding a plurality of terminals therein;
a metallic shield enclosing said terminal block, said shield including a plurality of peripheral walls defining a receiving cavity receiving a module therein, said shield defining a cutout laterally extending through the corresponding peripheral wall while with a connection protrusion outwardly linking two opposite inner edges of said corresponding wall beside said cutout; wherein
the module defines a rib vertically received in said cutout and horizontally surrounding by said connection protrusion,

14. The electrical connector as claimed in claim 13, wherein said shield is formed by an extended sheet, and a joined seam line for said peripheral walls is not aligned with said cutout in a vertical direction.
